(19) United States
(12) Patent Application Publication
(10) Pub. No.: US 2008/0190553 A1
(43) Pub. Date: Aug. 14, 2008

(54) METHOD OF MANUFACTURING ELECTROPHORETIC DISPLAY DEVICE

(75) Inventors: Byeong-Seob BAN, Seongnam-si (KR); Sung-Sik SHIN, Yongin-si (KR); Nam-Seok ROH, Seongnam-si (KR); Sang-Il KIM, Yongin-si (KR); Woo-Jae LEE, Yongin-si (KR); Mi-Jung HAN, Yongin-si (KR)

Correspondence Address: CANTOR COLBURN, LLP, 20 Church Street, 22nd Floor, Hartford, CT, 06103, US

(73) Assignee: SAMSUNG ELECTRONICS CO., LTD, Suwon-si (KR)

(21) Appl. No.: 12/025,957

(22) Filed: Feb. 5, 2008

(30) Foreign Application Priority Data
Feb. 14, 2007 (KR) 10-2007-0015401

(51) Int. Cl. B29C 65/00

(52) U.S. Cl. 156/275.5; 156/60

(57) ABSTRACT

A method of manufacturing an electrophoretic display (“EPD”) device includes preparing a first substrate, forming a sealing line on the first substrate, primarily curing the sealing line, filling a capsule composition within an area of the first substrate, adhering an opposite substrate to the first substrate, and secondarily curing the sealing line.

This application claims priority to Korean Patent application No. 2007-0015401, filed on Feb. 14, 2007, and all the benefits accruing therefrom under 35 U.S.C. §119, the contents of which in its entirety are herein incorporated by reference.

### BACKGROUND OF THE INVENTION

1. Field of the Invention

The present invention relates to a method of manufacturing an electrophoretic display (“EPD”) device, and more particularly, to a method of manufacturing an EPD device which reduces processing time and improves productivity.

2. Description of the Related Art

The electrophoretic display (“EPD”) device is a type of flat panel display device used in an electronic book. The EPD device includes two display substrates in which electric field generating electrodes are formed and a capsule formed between the two substrates and including electronic ink which has pigment particles charged positively and negatively respectively.

In the EPD device, a voltage is applied to two facing electrodes to generate a potential difference on both of the electrodes, and thus, the charged pigment particles are moved to the electrodes having different polarities so as to display images.

The EPD device is high in reflectivity and contrast, and has no limit to a viewing angle unlike a liquid crystal display (“LCD”) device. Accordingly, the EPD device can display images with ease as when it displays the images on paper. Further, in the EPD device, power consumption is low because the pigment particles maintain its state by voltage applied only one time, without voltage applied continuously.

Different from the LCD device, the EPD device does not require an alignment layer, a liquid crystal, etc. to have a flat panel display, thus resulting in a high price competitiveness.

### BRIEF SUMMARY OF INVENTION

Exemplary embodiments of the present invention provide a method of manufacturing an electrophoretic display (“EPD”) device which is reduced in processing time and improved in productivity.

Exemplary embodiments of the present invention provide a method of manufacturing an EPD device, including preparing a first substrate, forming a sealing line on the first substrate, primarily curing the sealing line, filling a capsule composition within an area of the first substrate, adhering an opposite substrate to the first substrate, and secondarily curing the sealing line.

The method of manufacturing the EPD device may further include controlling a humidity of the capsule composition filled in the area of the first substrate formed by the sealing line.

The sealing line may be primarily cured by heat treatment or ultraviolet treatment of the sealing line.

Primarily curing the sealing line may include primarily curing the sealing line about 50 to about 95%. Accordingly, filling the capsule composition and adhering the opposite substrate are performed with ease.

Further, forming the sealing line may include forming a partition wall which partitions the area of the first substrate formed by the sealing line into a plurality of pixel areas, to thereby fill a different capsule composition to each pixel area. Here, the partition wall may be made of a same material as the sealing line. Accordingly, the partition wall and the sealing line may be formed by only one process.

The capsule composition may be filled in each pixel area which is partitioned by the partition wall by using an inkjet injection. Here, the capsule composition may include a color capsule, that is, a capsule having a charged particle with a color.

Further, the humidity of the capsule composition may be controlled by heating the first substrate, such as by controlling the humidity of the capsule composition in a vacuum state, so as to control the humidity in a short time.

Furthermore, adhering the opposite substrate to the first substrate may include pressing the opposite substrate by a pressing roller against the first substrate. The opposite substrate may be made of a flexible material.

The first substrate may include a thin film transistor substrate having a thin film transistor array and the opposite substrate may include a color filter substrate having a color filter array.

The first substrate may include a color filter substrate having a color filter array and the opposite substrate may include a thin film transistor substrate having a thin film transistor array.

### BRIEF DESCRIPTION OF THE DRAWINGS

The above features and aspects of the present invention will become apparent and more readily appreciated from the following description of the exemplary embodiments, taken in conjunction with the accompanying drawings, in which:

FIG. 1 is a schematic cross-sectional view of an exemplary electrophoretic display (“EPD”) device according to an exemplary embodiment of the present invention;

FIG. 2 is a cross-sectional view illustrating an exemplary thin film transistor (“TFT”) substrate in FIG. 1;

FIG. 3 is a diagram for illustrating a configuration and operation of an exemplary capsule in FIG. 1;

FIG. 4 is a cross-sectional view for illustrating an exemplary color EPD device according to another exemplary embodiment of the present invention;

FIGS. 5A to 5D are diagrams for illustrating an exemplary process of manufacturing an exemplary EPD device according to a first exemplary embodiment of the present invention;

FIGS. 6A to 6D are diagrams for illustrating an exemplary process of manufacturing an exemplary EPD device according to a second exemplary embodiment of the present invention;

FIGS. 7A to 7D are diagrams for illustrating an exemplary process of manufacturing an exemplary EPD device according to a third exemplary embodiment of the present invention; and,

FIGS. 8A to 8D are diagrams for illustrating an exemplary process of manufacturing an exemplary EPD device according to a fourth exemplary embodiment of the present invention.

### DETAILED DESCRIPTION OF THE INVENTION

Reference will now be made in detail to the exemplary embodiments of the present invention, examples of which are illustrated in the accompanying drawings, wherein like reference numerals refer to like elements throughout. The embodiments are described below so as to describe the present invention by referring to the figures.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, the present invention will be described in detail with reference to the accompanying drawings.

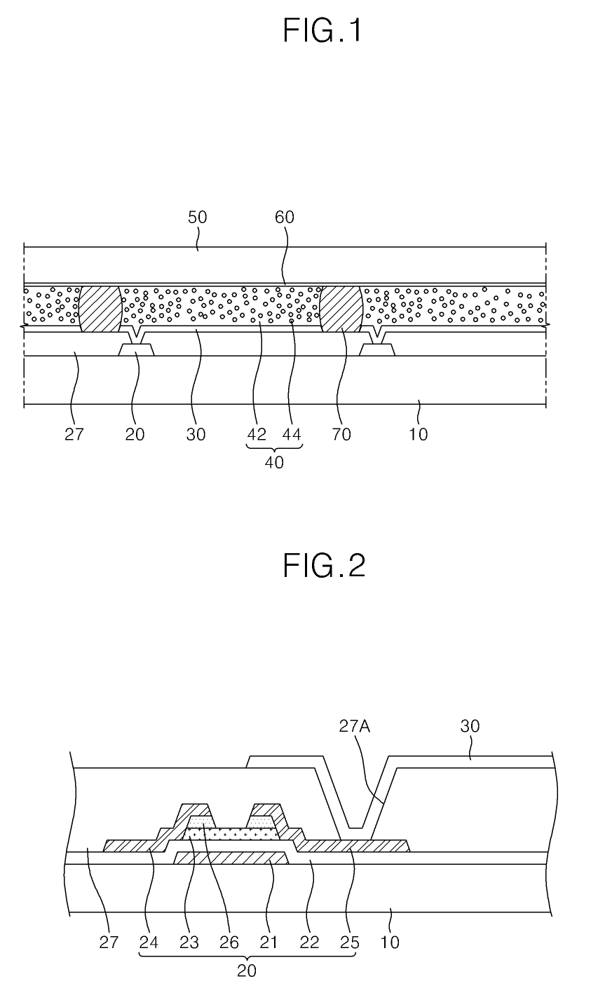

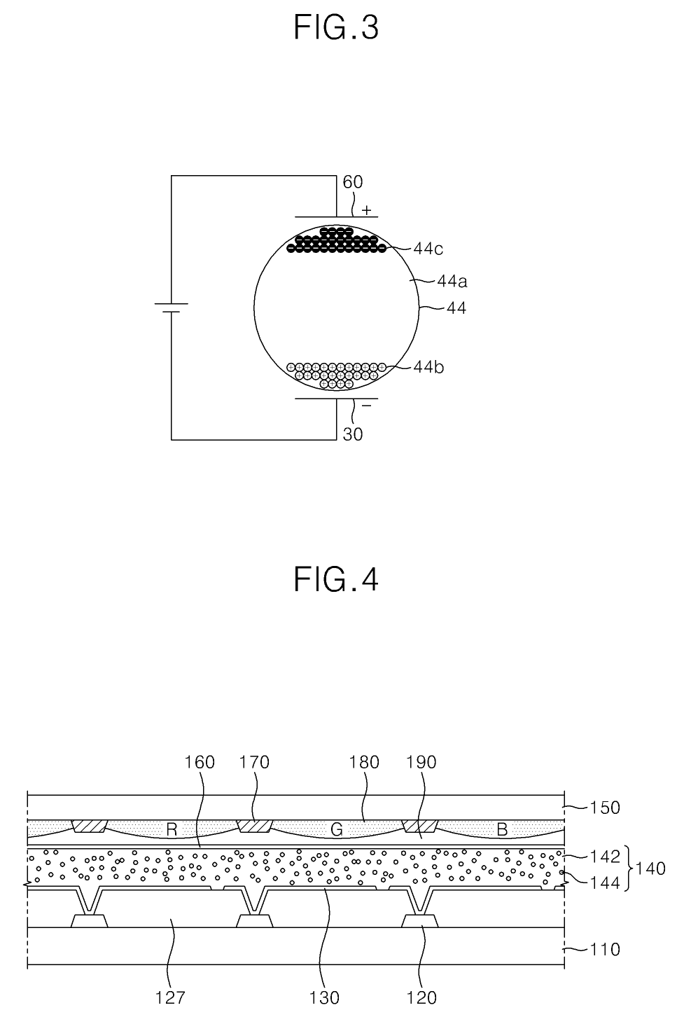

A color electrophoretic display (“EPD”) device according to an exemplary embodiment of the present invention will be described with reference to FIGS. 1 to 3. FIG. 1 is a schematic cross-sectional view of an exemplary EPD device according to the exemplary embodiment of the present invention; FIG. 2 is a cross-sectional view illustrating an exemplary thin film transistor (“TFT”) substrate in FIG. 1; and FIG. 3 is a diagram for illustrating a configuration and operation of an exemplary capsule in FIG. 1.

As shown in FIG. 1, the EPD device according to an exemplary embodiment includes a TFT substrate 10, a TFT 20, a pixel electrode 30, a display layer 40 also referred to herein as a capsule composition 40, an opposite substrate 50, a common electrode 60 and a partition wall 70.

The TFT substrate 10 is made of a transparent or non-transparent material and has a thin panel shape. The TFT substrate 10 may be formed of glass, plastic or steel foil. When the EPD device is manufactured with a flexible sheet shape, a flexible plastic substrate material may be used. For example, the TFT substrate 10 may be formed of a transparent and flexible polyethylene terephthalate (“PET”) material.

The TFT 20 and the pixel electrode 30 are formed on the TFT substrate 10 so as to operate each pixel independently from other pixels.

The TFT 20 which is formed on the TFT substrate 10 may include a gate electrode 21, a gate insulating layer 22, an active layer 23, an ohmic contact layer 26, a source electrode 24, and a drain electrode 25, by way of example.

The gate electrode 21 is connected to a gate line (not shown) and applies a scan signal to the TFT 20. The gate electrode 21 may be made of a single layer including silver (Ag), Ag alloy, aluminum (Al) or Al alloy of a low resistivity. Alternatively, the gate electrode 21 may be made of a multi-layer further including another layer which includes chromium (Cr), titanium (Ti) or tantalum (Ta) having good physical and electrical contact characteristics, in addition to the single layer.

Furthermore, the gate insulating layer 22 insulates the gate electrode 21 from the source and drain electrodes 24 and 25 or the gate electrode 21 from the active layer 23. The gate insulating layer 22 may be made of silicon nitride (SiNx), silicon oxide (SiOx) or the like. The gate insulating layer 22 may cover the gate line as well as exposed portions of the TFT substrate 10.

The active layer 23 is formed on the gate insulating layer 22 to be overlapped with the gate electrode 21. The active layer 23 forms a channel between the source electrode 24 and the drain electrode 25. The active layer 23 may be formed of hydrogenated amorphous silicon (“a-Si”) or the like.

The ohmic contact layer 26 may be formed on the active layer 23. The ohmic contact layer 26 decreases contact resistance of the source and drain electrodes 24 and 25 and the active layer 23, and reduces difference of work function therebetween, thereby improving characteristics of the TFT 20. The ohmic contact layer 26 may be made of silicide or n+hydrogenated a-Si in which an n-type impurity is doped at high concentration.

The source electrode 24 is connected to a data line (not shown) and applies a data signal to the TFT 20. Further, the drain electrode 25 is formed to face the source electrode 24, while separated from the source electrode 24, and is connected to the pixel electrode 30. The source electrode 24 and the drain electrode 25 may be formed of a singular or multi layer like the gate electrode 21, and may be substantially made of the same material as the gate electrode 21.

Although not shown, the TFT substrate 10 may include a plurality of gate lines and data lines, with the gate lines extending substantially in a first direction and the data lines extending substantially in a second direction substantially perpendicular to the first direction. At least one TFT 20 may be connected to each of the gate lines and data lines, such that a matrix of TFTs 20 may be provided on the TFT substrate 10.

A passivation layer 27 is formed on the TFT 20 and protects the TFT 20. The passivation layer 27 may be further formed on exposed portions of the gate insulating layer 22. Also, the passivation layer 27 insulates the source and drain electrodes 24 and 25 from the pixel electrode 30. The passivation layer 27 may be formed of an inorganic insulating layer including SiNx, SiOx, or the like, and may be a dual layer in which an organic insulating layer is formed on an inorganic insulating layer.

A contact hole 27A exposing a part of the drain electrode 25 is formed through the passivation layer 27. The pixel electrode 30 is connected to the drain electrode 25 through the contact hole 27A.

A pixel voltage supplied through the drain electrode 25 is applied to the pixel electrode 30. Accordingly, the pixel electrode 30 forms an electric field in cooperation with the common electrode 60 formed on the opposite substrate 50. Charged particles inside a capsule 44 move in a predetermined direction by the electric field to display a color. The pixel electrode 30 may be formed of indium tin oxide (“ITO”), tin oxide (“TO”), indium zinc oxide (“IZO”), SnO2, amorphous indium tin oxide (“a-ITO”), or the like.

In an exemplary embodiment, the TFT 20 and the pixel electrode 30 are provided with a plurality of pixel areas which is partitioned by the partition wall 70, so that each pixel can display images independently.

The display layer 40 is formed inside the pixel area which is partitioned by the partition wall 70. The display layer 40 may include the capsules 44 which are dispersed in a carrier 42 in the exemplary embodiment, but manners for dispersing the capsules 44 within the display layer 40 would be within the scope of these embodiments. The carrier 42 may function as a binder. More specifically, the carrier 42 may be used as the binder which binds the capsules 44 in the display layer 40. Further, the carrier 42 may take a variety of states from a gel state having a predetermined viscosity to a liquid state.

As shown in FIG. 3, an insulating material 44a, white charged particles 44b and color charged particles 44c may be filled in the capsules 44. Accordingly, the white charged particles 44b and the color charged particles 44c move inside a defined area of the capsules 44. The capsules 44 are provided for enhancing the manufacturing efficiency of the EPD device and preventing the display layer 40 from being deteriorated by an increase of operation time of the EPD device.

The insulating material 44a which is filled in the capsules 44 may be liquid or gas. The insulating material 44a functions as a medium which can move the charged particles 44b and 44c by an electric field and a fluid in which electricity does not flow may be used as the insulating material 44a. The insulating material 44a is determined to be liquid or gas according to the charged particles 44b and 44c. In general, when the insulating material 44a is gas, an operating speed of the EPD device is relatively excellent because a moving speed of the charged particles 44b and 44c is high. Accordingly, for example, the insulating material 44a may be air as an exemplary gas.

The color charged particles 44c are dispersed inside the insulating material 44a and have a certain polarity. The color charged particles 44c are positively or negatively charged so as to move in a particular direction by an electric field formed by applying direct voltages having different polarities to the pixel electrode 30 and the common electrode 60. For example, when the color charged particles 44c are negatively charged, the color charged particles 44c are moved in a direction of the positively charged common electrode 60, as shown in FIG. 3, and reflect all incident light from outside. Then, the pixel displays a color. A color of the color charged particles 44c is determined by position of the pixel, and may be selected from red R, green G and blue B.

The white charged particles 44b are also dispersed inside the insulating material 44a like the color charged particles 44c. The white charged particles 44b are charged of opposite polarity from the color charged particles 44c. Accordingly, the white charged particles 44b and the color charged particles 44c are mixed inside the capsule 44 before a voltage is applied to the pixel.

As shown in FIG. 3, the white charged particles 44b are charged of opposite polarity to the color charged particles 44c. For example, the white charged particles 44b are positively charged and the color charged particles 44c are negatively charged. Accordingly, when power is applied to the pixel electrode 30 and the common electrode 60, for example, when the pixel electrode 30 is negatively charged and the common electrode 60 is positively charged, the white charged particles 44b move in an opposite direction to the color charged particles 44c, such as the white charged particles 44b move towards the pixel electrode 30 and the color charged particles 44c move towards the common electrode 60. Although not shown, in the example where the white charged particles 44b are positively charged and the color charged particles 44c are negatively charged, when the pixel electrode 30 is positively charged and the common electrode 60 is negatively charged, then the white charged particles 44b would move towards the common electrode 60 and the color charged particles 44c would move towards the pixel electrode 30. Also although not shown, it should be understood that when the color charged particles 44c were positively charged and the white charged particles 44b were negatively charged, then the particles 44c, 44b would correspondingly move toward an oppositely charged electrode 30, 60. According to another exemplary embodiment, black charged particles instead of the white charged particles 44b may be mixed with the color charged particles 44c inside the capsule 44.

The opposite substrate 50 is adhered on the TFT substrate 10. The opposite substrate 50 is made of a transparent material so that incident light from the outside can pass therethrough. Accordingly, the opposite substrate 50 may be formed of a plastic material such as a transparent PET. In particular, the opposite substrate 50 may be formed of a flexible material for the convenience of the manufacturing process.

The common electrode 60 is formed on the opposite substrate 50. The common electrode 60 may be formed of a transparent conductive material, such as ITO, TO, IZO, SnO2, a-ITO, or the like. The common electrode 60 is formed over an overall surface of the opposite substrate 50, or at least substantially an entire surface of the opposite substrate 50, and forms an electric field in cooperation with the pixel electrode 30.

The opposite substrate 50 and the common electrode 60 are formed of a transparent material so that outside light can pass therethrough. The EPD device is a reflex display device. Accordingly, incident light from the outside should arrive at the charged particles 44b and 44c by passing through the opposite substrate 50 and the common electrode 60 without loss of the incident light. Thus, the opposite substrate 50 and the common electrode 60 are formed of a transparent material in which the incident light is transmitted without loss of light.

Hereinbelow, a color EPD device according to another exemplary embodiment of the present invention will be described with reference to FIG. 4. FIG. 4 is a cross-sectional view for illustrating an exemplary color EPD device according to another exemplary embodiment of the present invention.

As shown in FIG. 4, the color EPD device includes a TFT substrate 110, a display layer 140 also referred to as a capsule composition 140, and a color filter substrate 150.

A TFT 120 which is formed corresponding to each pixel area, a passivation layer 127 which is formed on the TFT 120, and a pixel electrode 130 which is connected to the TFT 120, are formed on the TFT substrate 110. The TFT substrate 110, the TFT 120 and the pixel electrode 130 may be substantially the same as the corresponding elements in the EPD device according to the first exemplary embodiment described above with respect to FIGS. 1 and 2 and therefore a repetitive description will be omitted.

In the exemplary EPD device shown in FIG. 4, there is no partition wall within the display layer 140, as there is in the first exemplary embodiment. Further, a capsule 144 which is dispersed in a carrier 142 in the display layer 140 is a black and a white capsule 144 displaying a black and a white color. That is, an insulating material is filled inside the capsule 144 and black charged particles and white charged particles are dispersed inside the insulating material. Because the EPD device of the present embodiment displays colors by a color filter 180, the capsule 144 may be the black and the white capsule 144 displaying the black and the white color. The capsule 144 is substantially the same as the capsule 44, except for the color of the charged particles.

As shown in FIG. 4, a black matrix 170, the color filter 180, an overcoat layer 190 and a common electrode 160 are formed on the color filter substrate 150 according to the present embodiment. The black matrix 170 is formed of a non-transparent layer in which light does not transmit. Further, the black matrix 170 partitions the color filter substrate 150 corresponding to the above-described pixel area. The black matrix 170 may be formed to correspond to and overlap with the gate lines, data lines, and TFTs 120 of the TFT substrate 110. The color filter 180 for each pixel area is positioned inside the area which is partitioned by the black matrix 170. Alternatively, the color filter 180 may slightly overlap the black matrix 170. In an exemplary embodiment, color filters 180 adjacent to each other have a different color.

The overcoat layer 190 is formed on the black matrix 170 and the color filter 180 to provide a flat surface of the color filter substrate 150. The overcoat layer 190 may be formed of an organic material.

The common electrode 160 is formed on the overcoat layer 190. A common voltage which is a reference voltage is applied to the common electrode 160. The common electrode 160 may be formed of a transparent conductive layer transmitting light, like the pixel electrode 130.

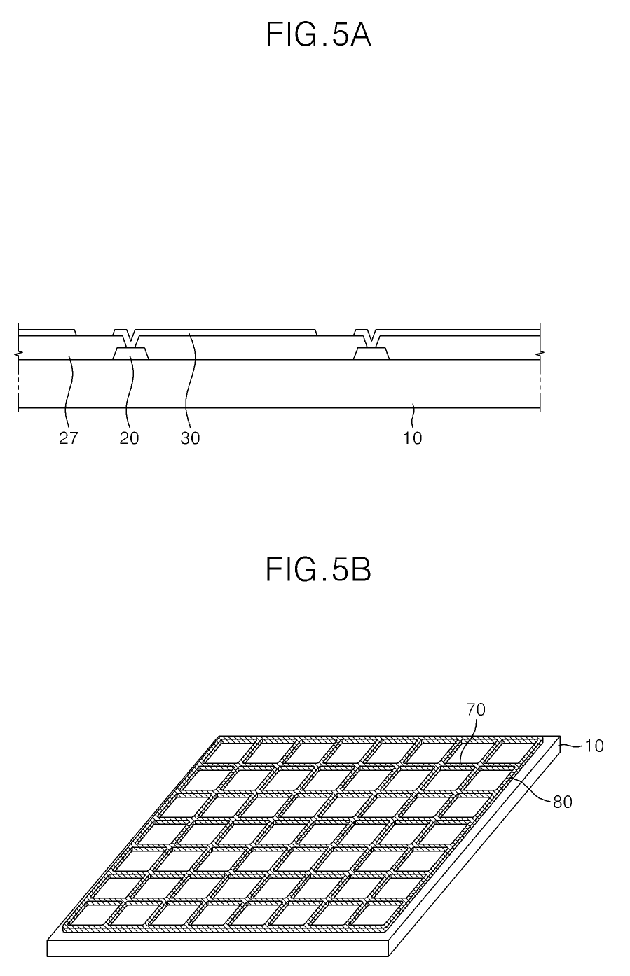

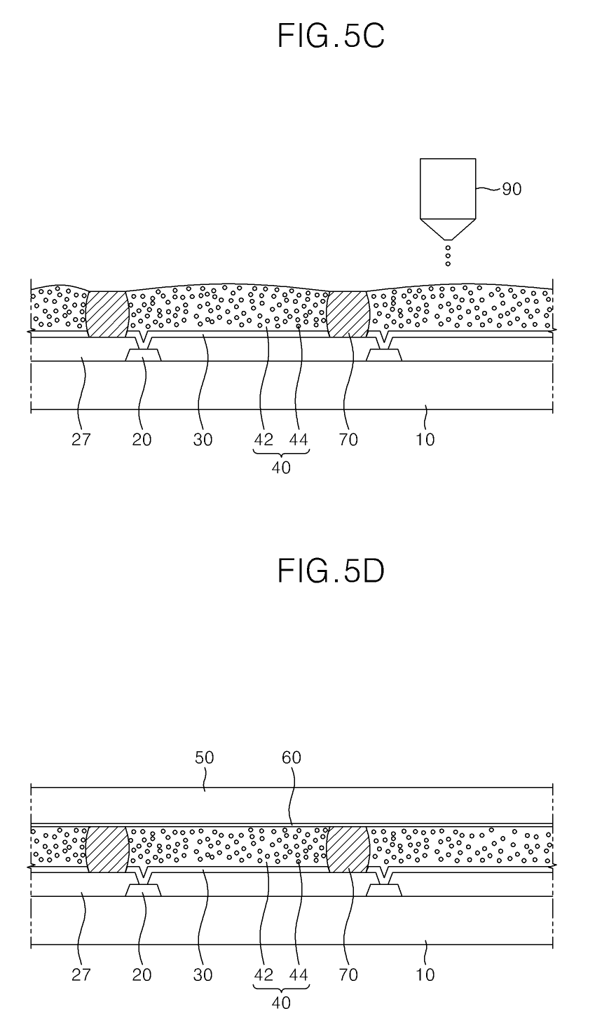

Hereinbelow, an exemplary method of manufacturing the exemplary EPD device according to a first exemplary embodiment of the present invention will be described with reference to FIGS. 5A to 5D, which are diagrams for illustrating the exemplary process of manufacturing the exemplary EPD device according to the first exemplary embodiment of the present invention.

At first, the TFT substrate 10 as shown in FIG. 5A is prepared. The TFT substrate 10 includes the TFT 20 and the pixel electrode 30 in each pixel area, arranged in a matrix type.

Next, as shown in FIG. 5B, a sealing line 80 is formed on the TFT substrate 10. The sealing line 80 adheres the TFT substrate 10 and an opposite substrate 50 to each other, and has a paste-like quality. As shown in FIG. 5B, the sealing line 80 has a rectangular shape. The sealing line 80 may define an outer rectangular periphery of a display area of the EPD device.

In an area formed by the sealing line 80, the partition wall 70 which partitions the area into a plurality of pixel areas with a predetermined size is formed. In an exemplary embodiment, the rectangular shape defined by the sealing line 80 may be sub-divided into a plurality of smaller rectangular shapes by the partition wall 70. The partition wall 70 is precisely formed so as to coincide with the pixel areas formed on the TFT substrate 10. The partition wall 70 may be formed of the same material as the sealing line 80, such that the partition wall 70 and the sealing line 80 may be formed at the same time, thereby simplifying the process and shortening the process time. Ultraviolet curing resin, heat curing resin, ultraviolet or heat composite curing resin may be used as the sealing line 80, as well as the partition wall 70.

The sealing line 80 and the partition wall 70 as shown in FIG. 5B may be formed using an imprint method or dispensing method.

Next, the sealing line 80 is primarily cured. Primarily curing the sealing line 80 prevents the sealing line 80, which has been already formed in the adhering process of the opposite substrate 50 in a subsequent operation, from being deformed. In the primarily curing process, the sealing line 80 is not completely cured. When the sealing line 80 is completely cured, then it would be impossible to adhere the opposite substrate 50 to the TFT substrate 10. The sealing line 80 may be cured about 50 to about 95%. When the sealing line 80 is cured 50% or less, the opposite substrate 50 is not fixed in place. On the other hand, when the sealing line 80 is cured 95% or more, that is, when the sealing line 80 is nearly completely cured, then the opposite substrate 50 can not be adhered to the TFT substrate 10.

In the primarily curing process of the sealing line 80, the partition wall 70 formed inside thereof is also primarily cured together with the sealing line 80.

A method of primarily curing the sealing line 80 is determined by a material of the sealing line 80. For example, when the sealing line 80 is made of ultraviolet curing resin, then the sealing line 80 is cured by ultraviolet rays. Alternatively, when the sealing line 80 is made of heat curing resin, then the sealing line 80 is cured by heat. Likewise, the method of primarily curing the partition wall 70, which is made of the same material as the sealing line 80, would be the same as the method of primarily curing the sealing line 80.

Then, as shown in FIG. 5C, a capsule composition 40, which forms the display layer 40 as previously described with respect to FIG. 1, is filled inside an area of the TFT substrate 10 which is formed by the sealing line 80. That is, the capsule composition 40 of a predetermined amount is filled in each pixel area which is partitioned by the partition wall 70. A method of filling the capsule composition 40 may include an inkjet injection method or a loading method and so on.

As shown in FIG. 5C, when the inkjet injection is used, the capsule composition 40 which displays a different color to each pixel is filled by an inkjet injection device 90. For example, when the capsule composition 40 which displays red is filled in a first pixel, the capsule composition 40 which displays green is filled in a second pixel and the capsule composition 40 which displays blue is filled in a third pixel. By repeating this filling process, the capsule composition 40 is filled in all the pixels on the TFT substrate 10.

Then, the humidity of the filled capsule composition 40 is controlled. That is, the carrier 42 of the filled capsule composition 40 in the pixel area which is partitioned by the partition wall 70 is evaporated, thereby enabling the charged particles inside the capsule 44 to move with ease. The humidity of the capsule composition 40 in which the charged particles move most easily is approximately 50%.

In an exemplary embodiment, the TFT substrate 10 is heated to control the humidity of the capsule composition 40. In an exemplary embodiment, the TFT substrate 10 is heated in a vacuum state for a short time. That is, after the TFT substrate 10 is installed in a chamber of the vacuum state, the substrate 10 is heated. By controlling the humidity in the vacuum state, it is possible to reduce the processing time compared with the case of controlling the humidity in an atmospheric state.

Next, the opposite substrate 50 is adhered to the TFT substrate 10. That is, as shown in FIG. 5D, after the opposite substrate 50 comes into contact with the TFT 10, the opposite substrate 50 and the TFT substrate 10 are adhered to each other by applying proper pressure. At this time, the sealing line 80 and the partition wall 70 provide adhesive force to adhere the opposite substrate 50 to the TFT substrate 10.

In an exemplary embodiment, the opposite substrate 50 is adhered to the TFT substrate 10 by a lamination method. More specifically, after the opposite substrate 50 moves onto the TFT substrate 10, the positions of the opposite substrate 50 and the TFT substrate 10 are aligned to properly coincide with each other. Thereafter, the opposite substrate 50 is moved adjacent to the TFT substrate 10 as close as possible. Then, the opposite substrate 50 is pressed from one side thereof to the other side thereof by a pressing roller and adhered to the TFT substrate 10. In order to employ the above-described lamination method, the opposite substrate 50 should be formed of a flexible material.

Next, subsequent to the opposite substrate 50 being adhered to the TFT substrate 10, the sealing line 80 is secondarily cured. That is, the sealing line 80 and the partition wall 70 which are incompletely cured in the primarily curing process are completely cured. In the secondarily curing process of the sealing line 80, the sealing line 80 is cured by heat treatment or ultraviolet treatment as in the primarily curing process. The partition wall 70 may also be completely cured during the secondarily curing process.

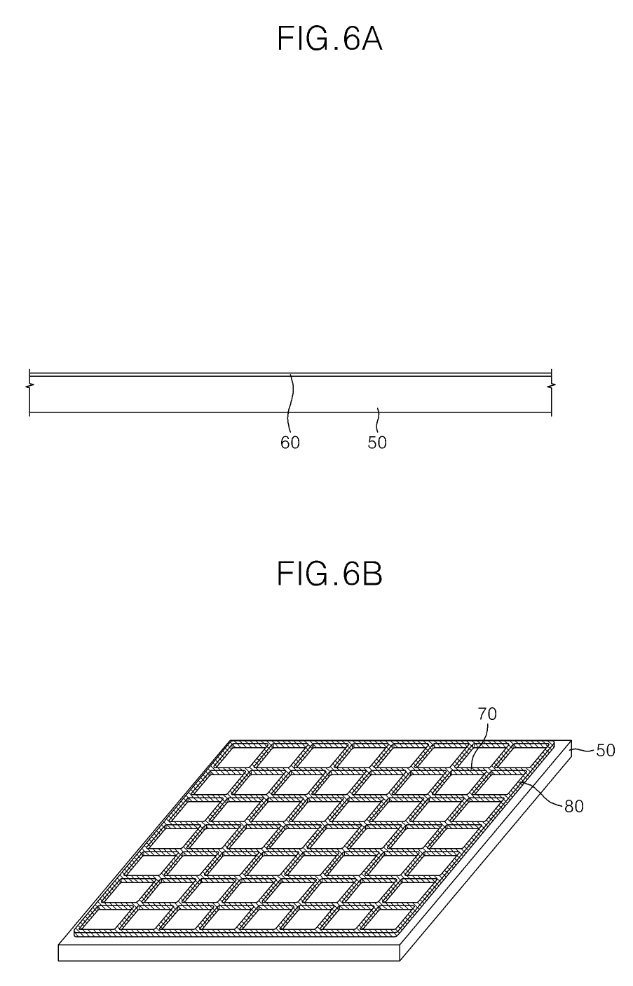

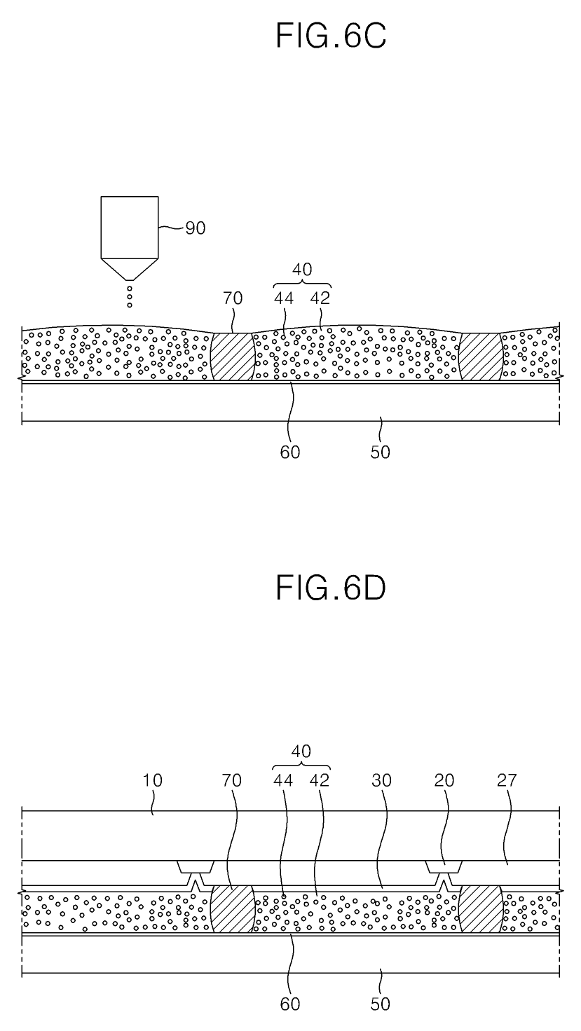

Hereinbelow, an exemplary method of manufacturing an exemplary EPD device according to a second exemplary embodiment of the present invention will be described with reference to FIGS. 6A to 6D, which are diagrams for illustrating the exemplary process of manufacturing the exemplary EPD device according to the second exemplary embodiment of the present invention.

At first, as shown in FIG. 6A, the opposite substrate 50 is prepared. The transparent common electrode 60 is formed on the opposite substrate 50.

Next, as shown in FIG. 6B, the sealing line 80 and the partition wall 70 are formed on the opposite substrate 50. Then, the sealing line 80 is primarily cured. Further, the partition wall 70, which is formed within a boundary of the sealing line 80 and of the same material as the sealing line 80, is primarily cured together with the sealing line 80.

Then, as shown in FIG. 6C, the capsule composition 40, which forms the display layer 40 in a completed EPD device shown in FIG. 1, is filled inside an area of the opposite substrate 50 which is formed by the sealing line 80. In an exemplary embodiment, the capsule composition 40 displaying a different color to each pixel is filled by an inkjet injection device 90.

As shown in FIG. 6D, the TFT substrate 10 is adhered to the opposite substrate 50, thereby achieving an EPD device as shown in FIG. 6D. Then, the sealing line 80 is secondarily cured. The partition wall 70 may be secondarily cured during the secondarily curing process of the sealing line 80.

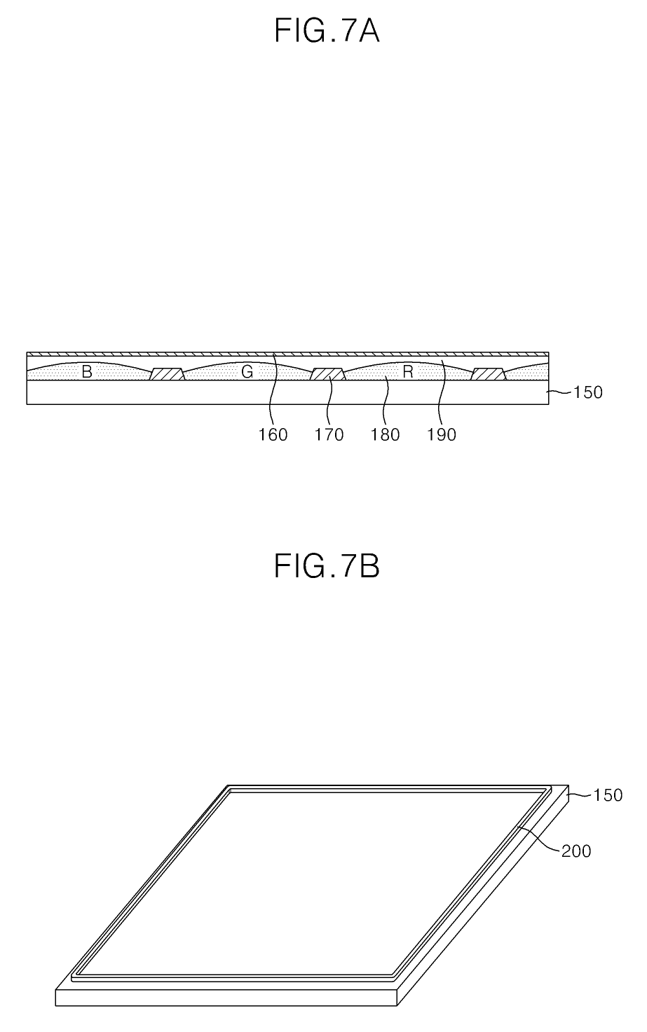

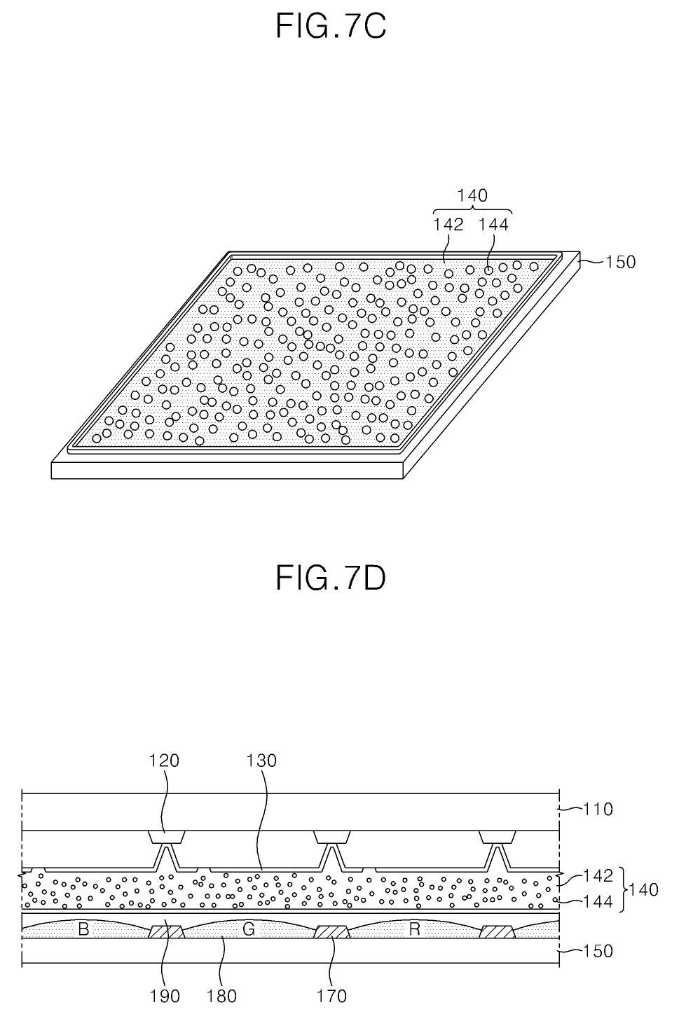

Hereinbelow, an exemplary method of manufacturing an exemplary EPD device according to a third exemplary embodiment of the present invention will be described with reference to FIGS. 7A to 7D, which are diagrams for illustrating the exemplary process of manufacturing the exemplary EPD device of the third exemplary embodiment of the present invention.

At first, as shown in FIG. 7A, the color filter substrate 150 is prepared. The black matrix 170, the color filter 180, the overcoat layer 190 and the common electrode 160 are formed on the color filter substrate 150.

As shown in FIG. 7B, a sealing line 200 is formed on the color filter substrate 150. The sealing line 200 adheres the color filter substrate 150 and the TFT substrate 110 to each other. As shown in FIG. 7B, the sealing line 200 forms a rectangular shape along edge parts of the color filter substrate 150. The sealing line 200 may define a periphery of the display area of the EPD device. Then, the sealing line 200 is primarily cured. The processes of forming the sealing line 200 and primarily curing the sealing line 200 are substantially the same the method of forming and primarily curing the sealing line 80 as described above with respect to the previous exemplary embodiments.

Next, a capsule composition 140, which forms the display layer 140 in the completed EPD device shown in FIG. 4, including the capsule 144 and the carrier 142 is filled inside an area of the color filter substrate 150 which is formed by the sealing line 200. That is, as shown in FIG. 7C, the capsule composition 140 having a predetermined amount is filled inside the sealing line 200. At this time, the amount of the filled capsule composition 140 should be precisely controlled so as to have the same volume as the rectangular space which is formed by the color filter substrate 150, the TFT substrate 110 and the sealing line 200.

Then, as the color filter 180 is used in this embodiment, the capsule 144 does not need to display color. Accordingly, the capsule 144 of the present embodiment may be a black and a white capsule 144 displaying a black and a white color.

Next, the humidity of the filled capsule composition 140 is controlled. The method of controlling the humidity of the capsule composition 140 may be substantially the same as the previously described method of controlling the humidity of the capsule composition 40. However, in this exemplary embodiment, the color filter substrate 150 may be heated instead of the TFT substrate 110 to control the humidity of the capsule composition 140.

Then, as shown in FIG. 7D, the TFT substrate 110 having an array of TFTs 120 is adhered to the color filter substrate 150. The adhering the TFT substrate 110 to the color filter substrate 150 may be accomplished by the above-described lamination method, in which case the TFT substrate 110 should be made of a flexible material.

Next, the sealing line 200 is secondarily cured. The process of secondarily curing the sealing line 200 may be the same as the method of secondarily curing the sealing line 80 described above with respect to the previous exemplary embodiments.

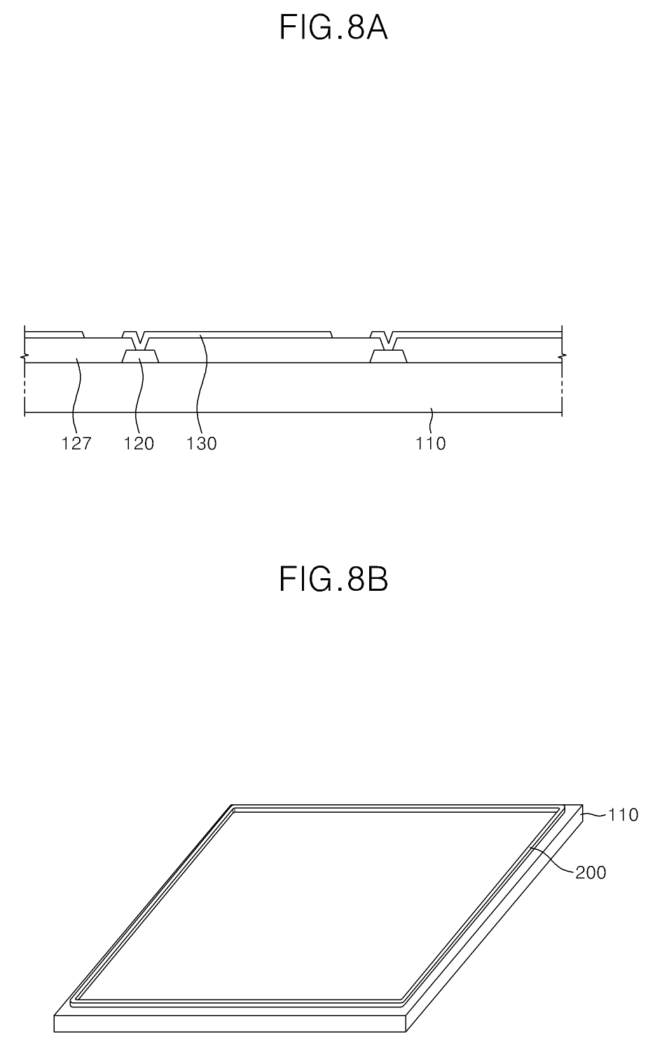

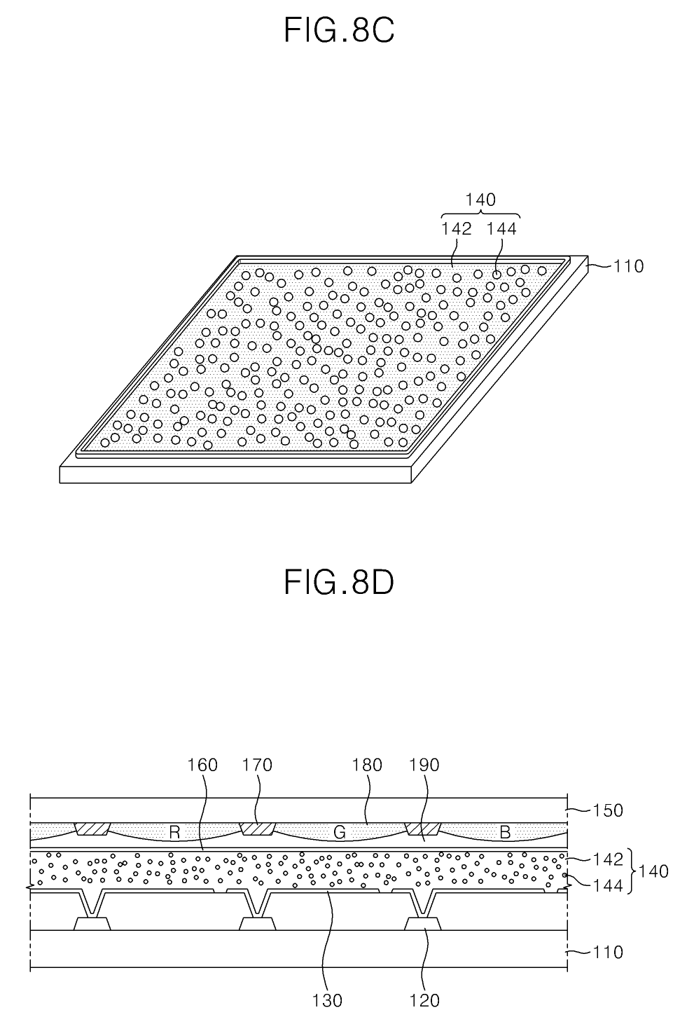

Hereinbelow, an exemplary method of manufacturing an exemplary EPD device according to a fourth exemplary embodiment of the present invention will be described with reference to FIGS. 8A to 8D, which are diagrams for illustrating the exemplary process of manufacturing the exemplary EPD device according to the fourth exemplary embodiment of the present invention.

The TFT substrate 110 is prepared as shown in FIG. 8A. As shown in FIG. 8A, the TFT 120, the pixel electrode 130, and the passivation layer 127 are formed on the TFT substrate 110.

As shown in FIG. 8B, the sealing line 200 is formed on the TFT substrate 110. Then, the sealing line 200 is primarily cured.

As shown in FIG. 8C, the capsule composition 140 including the capsule 144 and the carrier 142 is filled in an area of the TFT substrate 110 which is formed by the sealing line 200. The capsule 144 of this embodiment is prepared as a black and a white capsule. Then, the humidity of the filled capsule composition 140 is controlled.

Next, the color filter substrate 150 having the color filter array is adhered to the TFT substrate 110. Thereafter, the sealing line 200 is secondarily cured, thereby providing an EPD device as shown in FIG. 8D.

According to the exemplary methods of manufacturing the exemplary EPD devices as describe above, the manufacturing time of the exemplary EPD devices can be reduced, thereby improving productivity thereof. Accordingly, a masse production of the exemplary EPD devices is available.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A method of manufacturing an electrophoretic display device, the method comprising:
preparing a first substrate;
forming a sealing line on the first substrate;
primarily curing the sealing line;
filling a capsule composition within an area of the first substrate;
adhering an opposite substrate to the first substrate; and
secondarily curing the sealing line.

2. The method of claim 1, further comprising controlling a humidity of the capsule composition filled in the area of the first substrate formed by the sealing line.

3. The method of claim 2, wherein controlling the humidity of the capsule composition includes heating the first substrate.

4. The method of claim 3, wherein controlling the humidity of the capsule composition includes controlling the humidity of the capsule composition in a vacuum state.

5. The method of claim 1, wherein primarily curing the sealing line includes heat treatment or ultraviolet treatment.

6. The method of claim 5, wherein primarily curing the sealing line includes primarily curing the sealing line about 50 to about 95%.

7. The method of claim 1, wherein the capsule composition comprises a capsule containing at least one charged particle having a color.

8. The method of claim 1, wherein forming the sealing line comprises forming a partition wall which partitions the area of the first substrate formed by the sealing line into a plurality of pixel areas.

9. The method of claim 8, wherein the partition wall is made of a same material as the sealing line.

10. The method of claim 8, wherein filing the capsule composition includes filling the capsule composition in each pixel area which is partitioned by the partition wall.

11. The method of claim 1, wherein the first substrate comprises a thin film transistor substrate including a thin film transistor array.

12. The method of claim 11, wherein the opposite substrate comprises a color filter substrate having a color filter array.

13. The method of claim 1, wherein the first substrate comprises a color filter substrate having a color filter array.

14. The method of claim 13, wherein the opposite substrate comprises a thin film transistor substrate including a thin film transistor array.

15. The method of claim 1, wherein adhering the opposite substrate to the first substrate comprises pressing the opposite substrate against the first substrate using a pressing roller.

16. The method of claim 1, wherein the opposite substrate comprises a flexible material.

17. The method of claim 1, wherein secondarily curing the sealing line includes heat treatment or ultraviolet treatment.
